(19) United States
(12) Patent Application Publication
(10) Pub. No.: US 2011/0176666 A1
(43) Pub. Date: Jul. 21, 2011

(54) METHODS AND SYSTEMS FOR LINE MANAGEMENT

(75) Inventors: Craig L. Reding, Midland Park, NJ (US); Mahesh Rajagopalan, Irving, TX (US); Alin D'Silva, Newton, MA (US); Ziauddin Majid, Irving, TX (US); Satya Raju, Irving, TX (US); John R. Reformato, East Meadow, NY (US); Shadman Zafar, Coppell, TX (US)

(73) Assignees: Verizon Data Services, Inc., Temple Terrace, FL (US); Telesector Reseources Group, Inc., New York, NY (US)

(21) Appl. No.: 13/074,457

(22) Filed: Mar. 29, 2011

Related U.S. Application Data
(62) Division of application No. 10/720,971, filed on Nov. 24, 2003.
Application No. 10/720,971 is a continuation-in-part of application No. 10/083,793, filed on Feb. 27, 2002.
Application No. 10/083,793 is a continuation-in-part of application No. 10/083,792, filed on Feb. 27, 2002, now Pat. No. 7,142,646.
Application No. 10/083,792 is a continuation-in-part of application No. 10/083,884, filed on Feb. 27, 2002, now Pat. No. 7,190,773.
Application No. 10/083,884 is a continuation-in-part of application No. 10/083,822, filed on Feb. 27, 2002, now Pat. No. 7,903,796.
Application No. 10/083,822 is a continuation-in-part of application No. 10/084,121, filed on Feb. 27, 2002, now abandoned.
(60) Provisional application No. 60/272,122, filed on Feb. 27, 2001.
(60) Provisional application No. 60/272,167, filed on Feb. 27, 2001.
(60) Provisional application No. 60/275,667, filed on Mar. 13, 2001.
(60) Provisional application No. 60/275,719, filed on Mar. 13, 2001.
(60) Provisional application No. 60/275,020, filed on Mar. 13, 2001.
(60) Provisional application No. 60/275,031, filed on Mar. 13, 2001.
(60) Provisional application No. 60/276,505, filed on Mar. 19, 2001.

(51) Int. Cl. H04M 11/00

(52) U.S. Cl. 379/93.01

(57) ABSTRACT

Methods and Systems are provided for managing one or more communications lines associated with a user of a communications network. A service center may receive from a user line management information regarding one or more of the user's communications lines. This line management information may include a request from the user to handle all calls to the communications line in a particular manner (e.g., forward all calls to a different number). This line management information may also include information regarding scheduling the handling of calls to the communications line (e.g., scheduling call forwarding) or a request to handle calls differently based on information identifying the origination of the call (e.g., caller-ID). The service center may then forward instructions to the communications network such that the components (e.g., SSP or SCP) of the communications network implement the user's modifications. Additionally, the service center may be provided with information, in real-time, regarding a call to the communications line that may include, for example, the caller-ID for the incoming call. The service center may then determine how the call should be handled and forward instructions to the communications network to handle the call according to the user's requests.

### RELATED APPLICATIONS

This application is a continuation-in-part of U.S. patent application Ser. No. 10/083,793, entitled “METHOD AND APPARATUS FOR CALENDARED COMMUNICATIONS FLOW CONTROL,” filed Feb. 27, 2002, Attorney Docket No. 01-1007; U.S. patent application Ser. No. 10/083,792, entitled “VOICE MAIL INTEGRATION WITH INSTANT MESSENGER,” filed Feb. 27, 2002, Attorney Docket No. 01-1001; U.S. patent application Ser. No. 10/083,884, entitled “DEVICE INDEPENDENT CALLER ID,” filed Feb. 27, 2002, Attorney Docket No. 01-1002; and U.S. patent application Ser. No. 10/083,822, entitled “METHOD AND APPARATUS FOR A UNIFIED COMMUNICATION MANAGEMENT VIA INSTANT MESSAGING,” filed Feb. 27, 2002, Attorney Docket No. 01-1004; U.S. patent application Ser. No. 10/084,121, entitled “CALENDAR-BASED CALLING AGENTS,” filed Feb. 27, 2002, Attorney Docket No. 01-1008, all of which claim priority to U.S. Provisional Patent Application Nos. 60/272,122, 60/272,167, 60/275,667, 60/275,719, 60/275,020, 60/275,031, and 60/276,505, and all of which are expressly incorporated herein by reference in their entirety.

Applicants also claim the right to priority under 35 U.S.C. §119(e) based on Provisional Patent Application No. 60/428,704, entitled “DIGITAL COMPANION,” filed Nov. 25, 2002; and Provisional Patent Application No. 60/436,018, entitled “DIGITAL COMPANION,” filed Dec. 26, 2002, both of which are expressly incorporated herein by reference in their entirety.

The present application also relates to U.S. patent application Ser. No. (______), entitled “METHODS AND SYSTEMS FOR DRAG AND DROP CONFERENCE CALLING,” Attorney Docket No. 03-1012; U.S. patent application Ser. No. (______), entitled “METHODS AND SYSTEMS FOR CONFERENCE CALL BUFFERING,” Attorney Docket No. 03-1013; U.S. patent application Ser. No. (______), entitled “METHODS AND SYSTEMS FOR COMPUTER ENHANCED CONFERENCE CALLING,” Attorney Docket No. 03-1014; U.S. patent application Ser. No. (______), entitled “METHODS AND SYSTEMS FOR REMOTE CALL ESTABLISHMENT,” Attorney Docket No. 03-1015; U.S. patent application Ser. No. (______), entitled “METHODS AND SYSTEMS FOR CALL MANAGEMENT WITH USER INTERVENTION,” Attorney Docket No. 03-1016; U.S. patent application Ser. No. (______), entitled “METHODS AND SYSTEMS FOR DIRECTORY INFORMATION LOOKUP,” Attorney Docket No. 03-1017; U.S. patent application Ser. No. (______), entitled “METHODS AND SYSTEMS FOR AUTOMATIC COMMUNICATION LINE MANAGEMENT BASED ON DEVICE LOCATION,” Attorney Docket No. 03-1018; U.S. patent application Ser. No. (______), entitled “METHODS AND SYSTEMS FOR ADAPTIVE MESSAGE AND CALL NOTIFICATION,” Attorney Docket No. 03-1019; U.S. patent application Ser. No. (______), entitled “METHODS AND SYSTEMS FOR A CALL LOG,” Attorney Docket No. 03-1020; U.S. patent application Ser. No. (______), entitled “METHODS AND SYSTEMS FOR AUTOMATIC FORWARDING OF CALLS TO A PREFERRED DEVICE,” Attorney Docket No. 03-1021; U.S. patent application Ser. No. (______), entitled “METHODS AND SYSTEMS FOR CONTACT MANAGEMENT,” Attorney Docket No. 03-1023; U.S. patent application Ser. No. (______), entitled “METHODS AND SYSTEMS FOR NOTIFICATION OF CALL TO PHONE DEVICE,” Attorney Docket No. 03-1024; U.S. patent application Ser. No. (______), entitled “METHODS AND SYSTEMS FOR SINGLE NUMBER TEXT MESSAGING,” Attorney Docket No. 03-1025; U.S. patent application Ser. No. (______), entitled “METHODS AND SYSTEMS FOR MULTI-USER SELECTIVE NOTIFICATION,” Attorney Docket No. 03-1026; U.S. patent application Ser. No. (______), entitled “METHODS AND SYSTEMS FOR CPN TRIGGERED COLLABORATION,” Attorney Docket No. 03-1027; and U.S. patent application Ser. No. (______), entitled “METHODS AND SYSTEMS FOR PREEMPTIVE REJECTION OF CALLS,” Attorney Docket No. 03-1028, all of which are expressly incorporated herein by reference in their entirety.

### TECHNICAL FIELD

The present invention relates generally to data processing systems and, more particularly, to a method and system for managing one or more communications lines associated with a user of a communications network.

### BACKGROUND

A wide variety of means exist for communication between users. For example, a user may conduct phone calls via a home phone, work phone, and mobile phone. In addition, users may also communicate using devices such as PC's, PDA's, pagers, etc. using manners of communicating as email and instant messaging.

Unfortunately, managing such a wide variety of communication means can be difficult. In particular, as a user changes location, communication with the user may vary. For example, while on travel, it may only be possible to reach a user by mobile phone. However, the user may best be reached by email while at work. Also, the user may wish to implement various rules for receiving and controlling communications. For example, to be reached at home, the user may want the home phone to ring three times before forwarding the call to a mobile phone. As another example, the user may wish to be paged each time an email is received from a particular person while away from the office.

A user may also wish to treat a phone call differently dependent on who is calling the user. For example, if a user receives a call from a caller that the user does not want to speak to at the moment, the user may want to send that call directly to voice mail. Also, if a user receives a call from a number that displays no caller ID information or that the user otherwise does not recognize, the user may wish to somehow specially treat the call because the caller is a potential telemarketer.

Accordingly, there is a need for methods and systems for providing a user with the capability to manage the user's communications lines.

### SUMMARY

Consistent with the purposes of the invention, as embodied and broadly described herein, methods and systems are provided for managing two or more communications lines associated with a user of a communications network. These methods and systems include receiving from the user over a data network line management information regarding two or more communications lines associated with an account for the user, determining that the received line management information includes a modification to at least one of the communications lines associated with the account, and transmitting an instruction to a component of the communications network to implement the modification to the at least one communications line.

In another aspect, method and systems are provided for managing one or more communications lines associated with a user of a communications network. These methods and systems include receiving from the user over a data network line management information regarding one or more communications lines associated with an account for the user, receiving from the communications network information regarding a call received on at least one of the communications lines associated with the account, determining handling of the call based on the received line management information, and transmitting to the communications network an instruction regarding the handling of the call, such that the communications network handles the call in accordance with the received line management information.

In yet another aspect, methods and systems are provided include receiving from the user over a data network line management information regarding one or more communications lines associated with an account for the user, determining that the received line management information includes a modification to at least one of the communications lines associated with the account, and transmitting an instruction to a service control point of the communications network to implement the modification to the at least one communications line.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

The accompanying drawings, which are incorporated in and constitute a part of this specification, illustrate one embodiment of the invention and, together with the description, serve to explain the principles of the invention.

FIG. 1 is a diagram of an exemplary data processing and telecommunications environment in which features and aspects consistent with the principals of the present invention may be implemented;

FIG. 2 is a diagram of an exemplary user terminal, consistent with the principals of the present invention;

FIG. 3 is a diagram of a voice network, consistent with the principles of the present invention;

FIG. 4 is a block diagram of a service center, consistent with the principles of the present invention;

FIG. 5 illustrates a logical architecture of an exemplary system, consistent with the principles of the present invention;

FIG. 6 illustrates an exemplary screen shot of a screen that may be displayed to a user in response to the user electing to activate call forwarding, consistent with the principles of the present invention;

FIG. 7 illustrates an exemplary screen shot of a screen that may be displayed to a user to select a number to which calls are to be forwarded, consistent with the principles of the present invention;

FIG. 8 illustrates an exemplary screen that may be displayed to a user to schedule call forwarding, consistent with the principles of the present invention;

FIG. 9 illustrates an exemplary screen for entering scheduling information for call forwarding, consistent with the principles of the present invention;

FIG. 10 illustrates an exemplary screen for entering scheduling information for call forwarding where the user has selected to repeat the settings, consistent with the principles of the present invention;

FIG. 11 illustrates an exemplary screen for entering scheduling information for call forwarding where the user has selected to repeat the settings weekly, consistent with the principles of the present invention;

FIG. 12 illustrates an exemplary screen for entering scheduling information for call forwarding where the user has selected to repeat the settings monthly, consistent with the principles of the present invention;

FIG. 13 illustrates an exemplary screen for entering scheduling information for call forwarding where the user has selected to repeat the settings yearly, consistent with the principles of the present invention;

FIG. 14 illustrates a more detailed screen that, for example, a user may be presented with for a particular contact in the user's contact book, consistent with the principles of the present invention;

FIG. 15 illustrates a flow for chart for an exemplary method for implementing user's selections, consistent with the principles of the present invention;

FIG. 16 illustrates a flow chart for a method for call forwarding by an SSP updated via a CFV update, consistent with the principles of the present invention;

FIG. 17 illustrates a method for call forwarding for an SSP providing AIN services, consistent with the principles of the present invention; and

FIG. 18 illustrates a flow chart of a method for forwarding calls based on the caller-ID of the call, consistent with the principles of the present invention.

### DETAILED DESCRIPTION

Reference will now be made in detail to exemplary embodiments of the present invention, examples of which are illustrated in the accompanying drawings. Wherever possible, the same reference numbers will be used throughout the drawings to refer to the same or like parts.

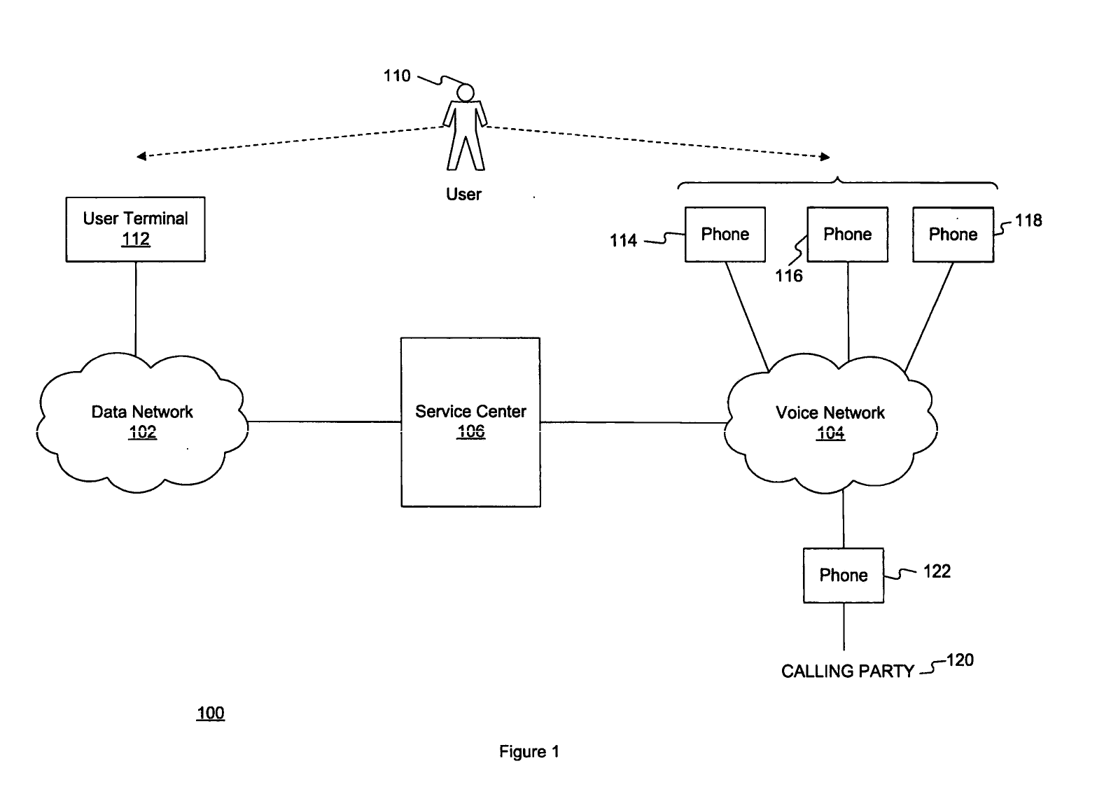

FIG. 1 is a block diagram of a data processing and telecommunications environment 100, in which features and aspects consistent with the present invention may be implemented. The number of components in environment 100 is not limited to what is shown and other variations in the number of arrangements of components are possible, consistent with embodiments of the invention. The components of FIG. 1 may be implemented through hardware, software, and/or firmware. Data processing and telecommunications environment 100 may include a data network 102, a voice network 104, and a service center 106. A user 110 may use a user terminal 112 to interface with data network 102 and may use phones 114, 116, and 118 to interface with voice network 104. A calling party 120 may use a phone 122 to call a user, such as user 110, at any one of phones 114, 116, and 118.

Data network 102 provides communications between the various entities depicted in environment 100 of FIG. 1, such as user terminal 112 and service center 106. Data network 102 may be a shared, public, or private network and encompass a wide area or local area. Data network 102 may be implemented through any suitable combination of wired and/or wireless communication networks. By way of example, data network 102 may be implemented through a wide area network (WAN), local area network (LAN), an intranet and/or the Internet. Further, the service center 106 may be connected to multiple data networks 102, such as, for example, to a wireless carrier network and to the Internet.

Voice network 104 may provide telephony services to allow a calling party, such as calling party 120, to place a call to user 110. In one embodiment, voice network 104 may be implemented using a network, such as the Public Switched Telephone Network (“PSTN”). Alternatively, voice network 104 may be implemented on a voice over broadband network, such as, for example, a network using voice-over Internet Protocol (“VoIP”) technology. Additionally, in other embodiments, voice network 104 may be a video over broadband network, such as, for example, a network for providing 2-way video communications. In another example, voice network 104 may be a wireless broadband network, such as, for example, a network using WiFi (i.e., IEEE 802.11(b) and/or (g)). In yet another example, voice network 104 may be a wireless voice network(s), such as, for example, a cellular or third-generation cellular network). In addition, voice network 104 may be implemented using any single or combination of the above-described technologies consistent with the principles of the present invention. Further, service center 106 may be connected to multiple voice networks 104, such as for example, Verizon's™ Voice Network, voice networks operated by other carriers, and wireless carrier networks.

Service center 106 provides a platform for managing communications over data network 102 and voice network 104. Service center 106 also provides gateway functions, such as code and protocol conversions, to transfer communications between data network 102 and voice network 104. Service center 106 may be implemented using a combination of hardware, software, and/or firmware. For example, service center 106 may be implemented using a plurality of general purpose computers or servers coupled by a network (not shown). Although service center 106 is shown with direct connections to data network 102 and voice network 104, any number and type of network elements may be interposed between service center 106, data network 102, and voice network 104.

User terminal 112 provides user 110 an interface to data network 102. For example, user terminal 112 may be implemented using any device capable of accessing the Internet, such as a general purpose computer or personal computer equipped with a modem. User terminal 112 may also be implemented in other devices, such as the Blackberry™, and Ergo Audrey™. Furthermore, user terminal 112 may be implemented in wireless devices, such as pagers, mobile phones (with data access functions), and Personal Digital Assistants (“PDA”) with network connections.

User terminal 112 also allows user 110 to communicate with service center 106. For example, user 110 may use instant messaging (“IM”) to communicate with service center 106. In addition, user terminal 112 may use other aspects of TCP/IP including the hypertext transfer protocol (“HTTP”); the user datagram protocol (“UDP”); the file transfer protocol (“FTP”); the hypertext markup language (“HTML”); and the extensible markup language (“XML”).

Furthermore, user terminal 112 may communicate directly with service center 106. For example, a client application may be installed on user terminal 112, which directly communicates with service center 106. Also, user terminal 112 may communicate with service center 106 via a proxy.

Phones 114, 116, 118, and 122 interface with voice network 104. Phones 114, 116, 118, and 122 may be implemented using known devices, including wireline phones and mobile phones. Although phones 114, 116, 118, and 122 are shown directly connected to voice network 104, any number of intervening elements, such as a private branch exchange (“PBX”), may be interposed between phones 114, 116, 118, and 122 and voice network 104.

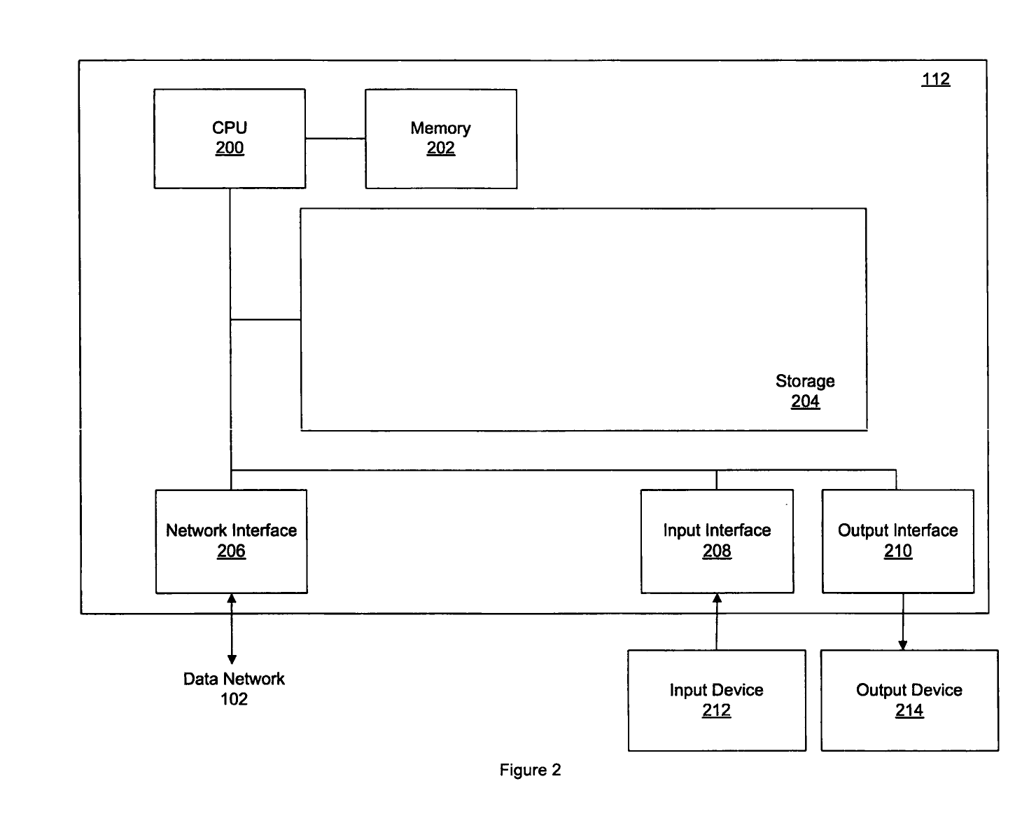

FIG. 2 is a block diagram of a user terminal consistent with the present invention. User terminal 112 includes a central processing unit (CPU) 200, a memory 202, a storage module 204, a network interface 206, an input interface 208, an output interface 210, an input device 216, and an output device 218.

CPU 200 provides control and processing functions for user terminal 112. Although FIG. 2 illustrates a single CPU, user terminal 112 may include multiple CPUs. CPU 200 may also include, for example, one or more of the following: a co-processor, memory, registers, and other processing devices and systems as appropriate. CPU 200 may be implemented, for example, using a Pentium™ processor provided from Intel Corporation.

Memory 202 provides a primary memory for CPU 200, such as for program code. Memory 202 may be embodied with a variety of components of subsystems, including a random access memory (“RAM”) and a read-only memory (“ROM”). When user terminal 112 executes an application installed in storage module 204, CPU 200 may download at least a portion of the program code from storage module 204 into memory 202. As CPU 200 executes the program code, CPU 200 may also retrieve additional portions of program code from storage module 204.

Storage module 204 may provide mass storage for user terminal 112. Storage module 204 may be implemented with a variety of components or subsystems including, for example, a hard drive, an optical drive, CD ROM drive, DVD drive, a general-purpose storage device, a removable storage device, and/or other devices capable of storing information. Further, although storage module 204 is shown within user terminal 112, storage module 204 may be implemented external to user terminal 112.

Storage module 204 includes program code and information for user terminal 112 to communicate with service center 106. Storage module 204 may include, for example, program code for a calendar application, such as GroupWise provided by Novell Corporation or Outlook provided by Microsoft Corporation; a client application, such as a Microsoft Network Messenger Service (MSNMS) client or America Online Instant Messenger (AIM) client; and an Operating System (OS), such as the Windows Operation System provided by Microsoft Corporation. In addition, storage module 204 may include other program code and information, such as program code for TCP/IP communications; kernel and device drivers; configuration information, such as a Dynamic Host Configuration Protocol (DHCP) configuration; a web browser, such as Internet Explorer provided by Microsoft Corporation, or Netscape Communicator provided by Netscape Corporation; and any other software that may be installed on user terminal 112.

Network interface 206 provides a communications interface between user terminal 112 and data network 102. Network interface 206 may receive and transmit communications for user terminal 112. For example, network interface 206 may be a modem, a local area network (“LAN”) port, a wireless modem, or a wireless data port.

Input interface 208 receives input from user 110 via input device 212 and provides the input to CPU 200. Input device 212 may include, for example, a keyboard, a microphone, and a mouse. Other types of input devices may also be implemented consistent with the principles of the present invention.

Output interface 210 provides information to user 110 via output device 214. Output device 214 may include, for example, a display, a printer, and a speaker. Other types of output devices may also be implemented consistent with the principles of the present invention.

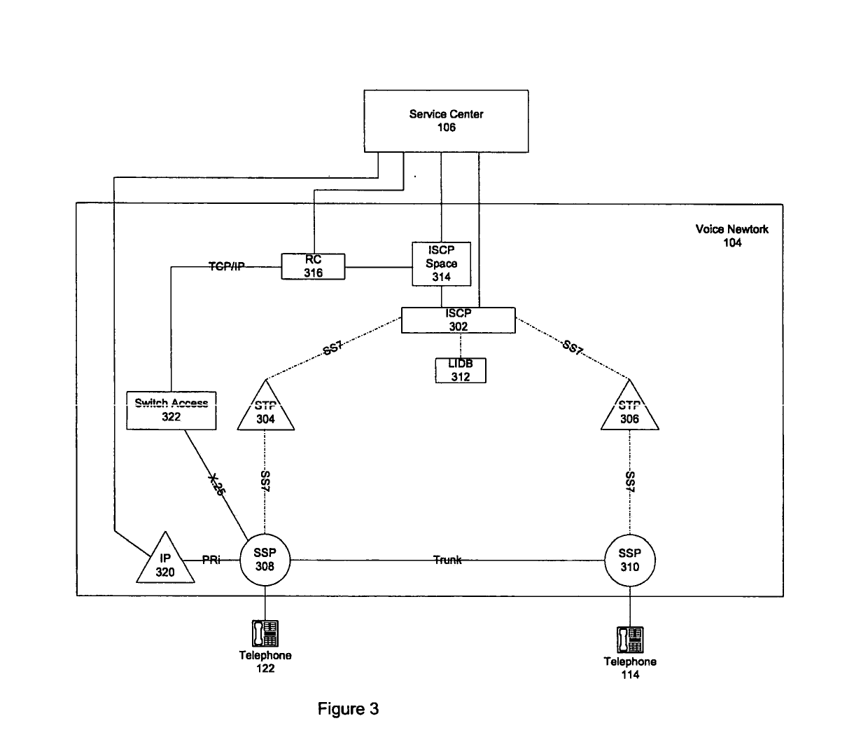

FIG. 3 is a diagram of a voice network, consistent with the principles of the present invention. As shown, voice network 104 includes an intelligent service control point (ISCP) 302, service transfer points (STP) 304 and 306, service switching points (SSP) 308 and 310, a line information database (LIDB) 312, an ISCP Service Provisioning And Creation Environment (SPACE) 314, a Recent Change Environment 316, and an Intelligent Peripheral (IP) 320. Although in this embodiment voice network 104 is described as a PSTN, as discussed above in other embodiments, voice network 104 may be, for example, a voice or video over broadband network a wireless broadband, a wireless voice network, etc.

Voice network 104 may be implemented using the PSTN and SS7 as a signaling protocol. The SS7 protocol allows voice network 104 to provide features, such as call forwarding, caller-ID, three-way calling, wireless services such as roaming and mobile user authentication, local number portability, and toll-free/toll services. The SS7 protocol provides various types of messages to support the features of voice network 104. For example, these SS7 messages may include Transaction Capabilities Applications Part (“TCAP”) messages to support event “triggers,” and queries and responses between ISCP 302 and SSPs 308 and 310.

ISCP 302 may also be, for example, a standard service control point (SCP), an Advanced Intelligent Network (AIN) SCP, a soft switch, or any other network call controller. As used herein, the term service control point (SCP) is a generic term that covers standard SCPs, ISCPs and AIN SCPs. ISCP 302 provides translation and routing services of SS7 messages to support the features of voice network 104, such as call forwarding. In addition, ISCP 302 may exchange information with the service center 106 using TCP/IP or SS7. ISCP 302 may be implemented using a combination of known hardware and software. ISCP 302 is shown with both a direct connection to service center 106 and a connection through ISCP SPACE 314, however, any number of network elements including routers, switches, hubs, etc., may be used to connect ISCP 302, ISCP SPACE 314, and service center 106. Further, information exchanged between ISCP 302 and service center 106 may use, for example, the SR-3389 General Data Interface (GOI) for TCP/IP.

STPs 304 and 306 relay SS7 messages within voice network 104. For example, STP 304 may route SS7 messages between SSPs 308 and 310. STP 302 may be implemented using known hardware and software from manufacturers such as NORTEL™ and LUCENT Technologies™.

SSPs 308 and 310 provide an interface between voice network 104 and phones 114 and 122, respectively, to setup, manage, and release telephone calls within voice network 104. SSPs 308 and 310 may be implemented as a voice switch, an SS7 switch, or a computer connected to a switch. SSPs 308 and 310 exchange SS7 signal units to support a telephone call between calling party 120 and user 110. For example, SSPs 308 and 310 may exchange SS7 messages, such as TCAP messages, within message signal units (“MSU”) to control calls, perform database queries to configuration database 312, and provide maintenance information.

Line Information Database (LIDB) 312 comprises one or more known databases to support the features of voice network 104. For example, LIDB 312 may include user information, such as a service profile, name and address, and credit card validation information. Although, in this figure, LIDB 312 is illustrated as directly connected to ISCP 302, LIDB 312 may be connected to ISCP 302 through an STP (e.g., 304 and 306). Additionally, this communication link may use, for example, the GR-2838 General Dynamic Interface (GDI) for SS7.

ISCP Service Provisioning and Creation Environment (SPACE) 314 may be included as part of ISCP 302 or be separate from ISCP 302. For example, the Telcordia™ ISCP may include an environment similar to SPACE 314 as part of the product. Further, ISCP SPACE 314 may include one or more servers. ISCP SPACE 314 is the point in the ISCP platform where user record updates may be made.

In one embodiment, user records may be stored in ISCP SPACE 314 such that the records may be updated and sent to ISCP 302. These records may include information regarding how to handle calls directed to the user. For example, these user records may include information regarding whether or not calls for the user are to be forwarded to a different number, and/or whether or not the call should be directed to an IP, such as a voice mail system, after a certain number of rings. Additionally, one ISCP SPACE 314 may provide updates to one or more ISCPs 302 via an ISCP network (not shown).

Additionally, the voice network 104 may include one or more recent change engines 316 such as, for example, an Enterprise Recent Change engine (eRC); an Assignment, Activation, and Inventory System (MIS); or a multi-services platform (MSP). As an example, the eRC and AAIS may be used in voice networks 104 located in the western part of the United States, while an MSP may be used in networks in the eastern part. The recent change engines may be used to update switch and ISCP databases. For example, a recent change engine may deliver database updates to SSPs and to ISCPs, such that when updating databases, these recent change engines emulate human operators. Additionally, if the instructions are to be sent to an ISCP 302, the recent change engine may first send the instructions to ISCP SPACE 314, which then propagates the instructions to ISCP 302 as discussed above. Further, an MSP may be used, for example, for providing updates to both SSPs 308 or 310 and ISCPs 302. Or, for example, an eRC may be used for providing updates to SSPs 308 or 310, while an AAIS is used for providing updates to the ISCPs 302. Additionally, updates sent to SSPs 308 or 310 may be sent from recent change engine 316 via a switch access 320 that may, for example, convert the updates into the appropriate protocol for SSP 308 or 310. For example, recent change engine 316 may send updates to SSPs 308 or 310 via TCP/IP. Switch access 320 may then convert the updates from TCP/IP to X.25. This switch access 320 may be any appropriate type of hardware and/or software. Additionally, these connections may include any number of elements, such as, for example, switches, routers, hubs, etc. and may be, for example, an internal data network for voice network 104.

Additionally, voice network 104 may include one or more intelligent peripherals (IP). For example, in FIG. 3, an IP 320 is illustrated as being connected to SSP 308. These IPs may be used for providing services, such as voice mail services. Additionally, the communications between SSP 308 and IP 320 may use the Primary Rate interface (PRi) (e.g., the 1129 protocol) protocol. Additionally, IP 320 may be capable of sending and receiving information to/from service center 106. These communications may use, for example, the SR-3511 protocol. Further, although FIG. 3 illustrates this connection as a direct connection, this connection may include any number of elements including routers, switches, hubs, etc., and may be via, for example, an internal data network for voice network 104.

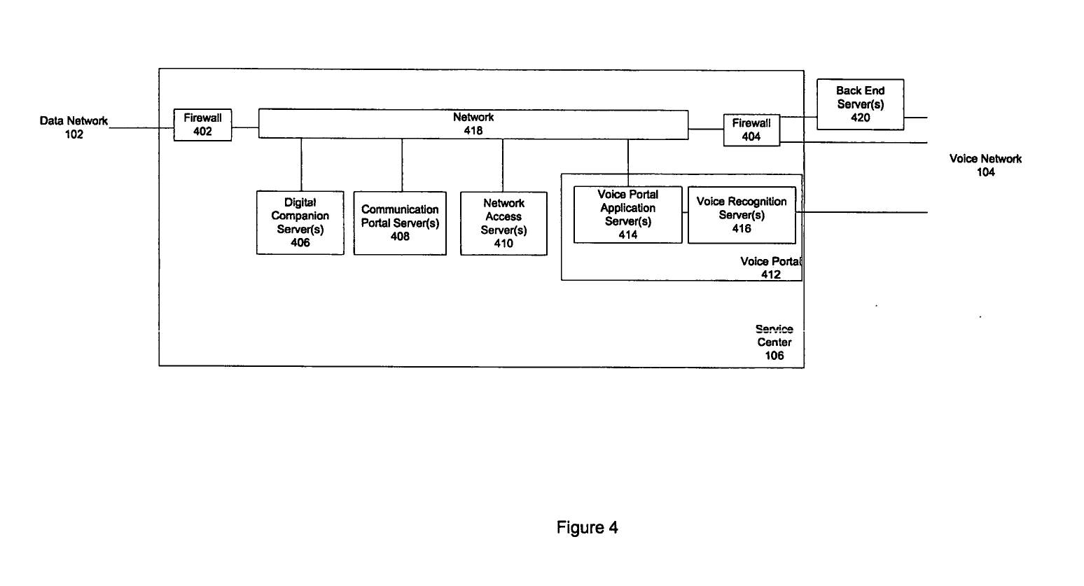

FIG. 4 is a block diagram of service center 106, consistent with the principles of the present invention. As shown, service center 106 may include firewalls 402 and 404, one or more digital companion servers 406, one or more communication portal servers 408, one or more network access servers 410, and a voice portal 412. Voice portal 412 may include a voice portal application server 414 and a voice recognition server 416. A network 418 may be used to interconnect the firewalls and servers. Additionally, back end server(s) 420 may be provided between the service center 106 and the voice network 104.

Firewalls 402 and 404 provide security services for communications between service center 106, data network 102, and voice network 104, respectively. For example, firewalls 402 and 404 may restrict communications between user terminal 112 and one or more servers within service center 106. Any appropriate security policy may be implemented in firewalls 402 and 404 consistent with the principles of the present invention. Firewalls 402 and 404 may be implemented using a combination of known hardware and software, such as the Raptor Firewall provided by the Axent Corporation. Further, firewalls 402 and 404 may be implemented as separate machines within service center 106, or implemented on one or more machines external to service center 106.

Network 418 may be any appropriate type of network, such as an Ethernet or FDDI network. Additionally, network 418 may also include switches and routers as appropriate without departing from the scope of the invention. Further, additional firewalls may be present in network 418, for example, to place one or more of servers 406, 408, 410, or voice portal 412 behind additional firewalls.

Each server (406, 408, 410, 414, 416, 420) may be any appropriate type of server or computer, such as a Unix or DOS based server or computer. The servers may implement various logical functions, such as those described below. In FIG. 4, a different server is illustrated as being used for each logical function. In other embodiments, the logical functions may be split across multiple servers, multiple servers may be used to implement a single function, all functions may be performed by a single server, etc.

In general, a digital companion server 406 may provide the software and hardware for providing specific services of the service center. Exemplary services include, for example, permitting a user to add contacts to the user's address book from a history of calls made or received by the user, permitting a user to make calls directly from the user's address book, scheduling a call to be placed at a specific time, or permitting the user to look at the name and/or address associated with a phone number. Additionally, these services may include permitting the user to listen to the user's voice mail on-line, forwarding the user's calls based on a scheduler and/or the calling parties number, setting up conference calls on-line, etc.

A communication portal server 408 may provide the hardware and software for managing a user's account and interfacing with user account information stored by the provider of user's voice network 104. Network access servers 410 may provide the hardware and software for sending and receiving information to voice network 104 in processing the applications provided by the service center. For example, network access servers 410 may be used for transmitting and/or receiving information from/to ISCP 302 or SSP 308 or 310 of voice network 104.

Voice portal 412 includes software and hardware for receiving and processing instructions from a user via voice. For example, a user may dial a specific number for voice portal 412. Then the user using speech may instruct service center 106 to modify the services to which the user subscribes. Voice portal 412 may include, for example, a voice recognition function 416 and an application function 414. Voice recognition function 416 may receive and interpret dictation, or recognize spoken commands. Application function 414 may take, for example, the output from voice recognition function 416, convert it to a format suitable for service center 106 and forward the information to one or more servers (406, 408, 410) in service center 106.

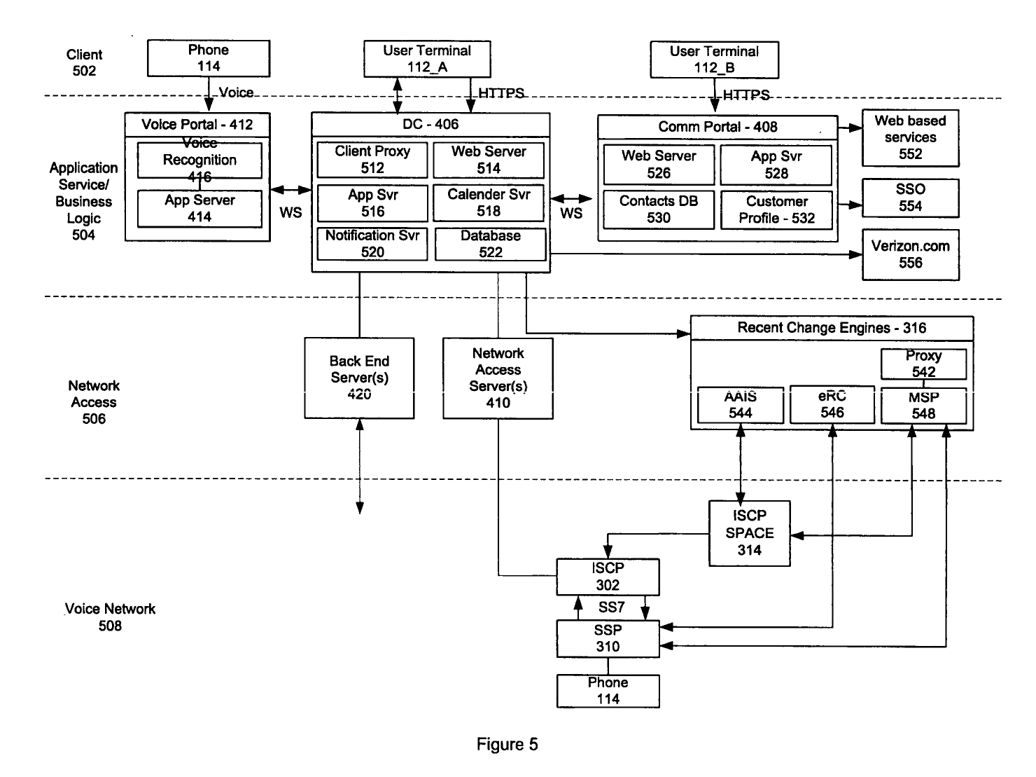

FIG. 5 illustrates a logical architecture of an exemplary system, consistent with the present invention. As illustrated, the logical architecture may be split into four planes: client side plane 502, application service plane 504, network access plane 506, and voice network plane 508.

Client side plane 502 includes user terminals 112_A and 112_B that a user may use to send and/or receive information to/from service center 106. Additionally, client side 502 includes user's phone(s) 114. As discussed above, user terminals 112 may be any appropriate type of device a user may use for communicating with service center 106. For example, user terminal 112_A may be a PDA running a program (e.g., a client application) for communicating with service center 106, while user terminal 112_B may be a desktop type computer running a web browser for communicating with the service center 106 via the Internet. Additionally, the user may have one or more phones 114, such as, for example, one or more standard landline telephones and/or wireless phones.

Application service plane 504 includes digital companion server(s) 406, communication portal servers) 408, and voice portal 412. These entities may communicate between one another using, for example, web services or any other suitable protocols. Web services are a standardized way of integrating Web-based applications using the Extensible Markup Language (XML), Simple Object Access Protocol (SOAP), Web Services Description Language (WSDL) and Universal Description, Discovery and Integration (UDDI) open standards over an Internet protocol (IP) backbone.

As illustrated, a digital companion server 406 may provide the following functions: a client proxy 512, a web server 514, an application server function 516, a calendar server function 518, a notification server function 520, and a database function 522. Each of these functions may be performed in hardware, software, and/or firmware. Further, these functions may each be executed by a separate server, split across multiple servers, included on the same server functions, or any other manner.

Client proxy function 512 provides a proxy function for the digital companion that may be used for security purposes. This client proxy function 512 may be included in a separate server such that all communications sent from the other digital companion functions/servers to a user terminal 112 via data network 102 go through client proxy 512. Also, if client proxy 512 is included on a separate server, for example, an additional firewall may be provided between client proxy 512 and the other digital companion servers to provide additional security.

Web server 514 provides functionality for receiving traffic over data network 102 from a user. For example, web server 514 may be a standard web server that a user may access using a web browser program, such as Internet Explorer or Netscape Communicator.

Application server function 516 encompasses the general functions performed by digital companion server(s) 406. For example, these functions may include interfacing with the various other digital companion functions to perform specific applications provided by the service center. These services may include, for example, interfacing with other function(s), software, and/or hardware to provide a user with the capability of managing the user's calls online. For example, permitting a user to add contacts to the user's address book from a history of calls made or received by the user, permitting a user to make calls directly from the user's address book, scheduling a call to be placed at a specific time, or permitting the user to look at the name and/or address associated with a phone number. Additionally, these services may include permitting the user to listen to the user's voice mail on-line, forwarding the user's calls based on a scheduler and/or the calling parties number, setting up conference calls on-line, etc.

Additionally, application server function 516 may interface with one or more external devices, such as an external web server, for retrieving or sending information. For example, application server function 516 may interface with a voice network's data center 556 (e.g., verizon.com) to determine the services to which the user subscribes (e.g., call waiting, call forwarding, voice mail, etc.).

Calendar server function 518 may provide the capability of scheduling events, logging when certain events occurred, triggering the application-functions to perform a function at a particular time, etc.

Notification server function 520 provides the capability to send information from the service center 106 to a user terminal 112. For example, notification server function 520 at the direction of application server function 516 may send a notification to user terminal 112 that the user is presently receiving a phone call at user's phone 114.

Database function 522 provides the storage of information useable by the various applications executed by the digital companion servers. These databases may be included in, for example, one or more external storage devices connected to the digital companion servers. Alternatively, the databases may be included in storage devices within the digital companion servers themselves. The storage devices providing database function 522 may be any appropriate type of storage device, such as for example, CD-ROMs, DVD's, disk drives, magnetic tape, etc.

As discussed above, communication portal server(s) 408 provide the hardware and software for managing a user's account and interfacing with user account information stored by the provider of user's voice network 104. As illustrated in FIG. 5, a communication portal server 408 may provide the following functions: a web server function 526, an application server function 528, a contacts database function 530, and/or a user profile function 532. Each of these functions may be performed by a separate server, split across multiple servers, included on the same server functions, or any other manner.

Web server function 526, as with web server function 522 of the digital companion servers, provides functionality for receiving traffic over data network 102 from a user. For example, the web server may be a standard web server that a user may access using a web browser, such as Internet Explorer or Netscape Communicator.

Application server function 528 encompasses the general functions performed by communication portal servers 406. For example, these functions may include interfacing with the voice network to retrieve and/or modify user profile information, and creating and editing an address book for the user. Additionally, application server function 528 may include the functionality of sending and/or receiving information to/from external servers and/or devices. For example, communication portal servers 408 may be connected to a network, such as, the Internet. Application server function 528 may then provide connectivity over the Internet to external servers 552 that provide web services, such as the Superpages webpage. Application function 528 could then contact these external services 552 to retrieve information, such as an address for a person in user's address book.

In another example, application server function 528 of communication portal 408 may interface a single sign on (SSO) server 554. SSO 554 may be used to allow users to access all services to which the user subscribes, on the basis of a single authentication that is performed when they initially access the network.

Contacts database 530 includes storage devices for storing an address book for the user. This address book may be any appropriate type of address book. For example, a user's address book may include the names, phone numbers, and addresses of people and/or organizations. The storage devices of database 530 may be internal or external to communication portal servers 406 or some combination in between. In addition, these storage devices may be any appropriate type of storage device, such as magnetic storage, memory storage, etc.

User profile database 532 includes storage devices for storing user profile information for the user. These storage devices may be the same or separate storage devices used for the contacts database. The user profile may include information regarding user's account for the user's voice network. For example, this information may include user's name, billing address, and other account information. Additionally, the user profile may include information regarding voice services to which the user subscribes, such as, for example, call waiting, voice mail, etc.

Additionally, application services plane 504 of the architecture may include a voice portal 412. As discussed above, voice portal 412 may include, for example, a voice recognition function 416 and an application server function 414, and be used for receiving and processing instructions from a user via voice. The voice recognition function may be implemented using hardware and/or software capable of providing voice recognition capabilities. This hardware and/or software may be a commercially available product, such as the Voice Application platform available from Tellme Networks, Incorporated. Application server function 414 of voice portal 412 may include hardware and/or software for exchanging information between digital companion servers 406 and voice recognition function 416. Additionally, application server function 414 may be included on a separate server, included in the hardware and software providing voice recognition function 416, included in digital companion servers 406, etc.

Network Access plane 506 of the architecture includes the functions for providing connectivity between application service plane 502 and voice network 104. For example, network access plane 506 may include the recent change engines 316, network access servers 410, and/or back end servers 420.

As discussed above, recent change engines 316 may be used to update switches and ISCP databases included in voice network 104. In one embodiment, recent change engines 316 may include an MIS 544, an eRC 546, and/or an MSP 548. Additionally, a proxy 542 may be used between digital companion servers 406 and recent change engines 542 for security purposes.

Network access servers 410 may be included in service center 106 and may provide the hardware and software for sending and receiving information to voice network 410 in processing the applications provided by the service center. For example, network access servers 410 may include a Caller ID (CID) functionality for retrieving caller ID information from the voice network 104, a click to dial (CTD) functionality for instructing an intelligent peripheral (IP) in the voice network to place a call via an SSP, and/or a real time call management (RTCM) functionality for interfacing with an ISCP of the voice network.

Network Access plane 506 may also include one or more back end server(s) 420. Back end server(s) 420 may include hardware and/or software for interfacing service center 106 and voice network 104. Back end server(s) 420 may be connected to service center 106 by a network, by a direct connection, or in any other suitable manner. Further, back end server(s) 420 may connect to one or more devices in voice network 104 by a network, a direct connection, or in any other suitable manner.

Back end server(s) 420 may include, for example, a server providing a voice mail retrieval and notification function. For example, this voice mail retrieval and notification function may include the capability to receive notifications when a user receives a voice mail, physically call a user's voice mail system, enter the appropriate codes to retrieve the voice mail, retrieve the voice mail, convert the voice mail to a digital file, and send it to digital companion servers 406.

Additionally, back end server(s) 420 may also include, for example, a directory assistance server. This directory assistance server may, for example, interface service center 106 with a Reverse Directory Assistance Gateway (RDA Gateway) of voice network 104. A RDA Gateway is a device for issuing requests to a Data Operations Center (DOC) of voice network 104 for name and/or address information associated with a phone number and receiving the name and/or phone number in response to this request.

In another example, back end server(s) 420 may include a wireless internet gateway that is used for interfacing with a mobile switching center (MSC) of a wireless voice network. As with the above-described back end server(s) 420, this wireless internet gateway may be used for converting requests and information between the formats used by service center 106 and those used by the wireless voice network.

In yet another example, back end server(s) 420 may include a conference blasting server for instructing a conference bridge in voice network 106 to dial out via an SSP to the participants of a voice conference. Or for example, the back end server(s) may include a server for instructing an IP of the voice network to place a call between two parties by dialing out to each of the parties. The back end server(s) may also include the capability to instruct the bridge or IP device to call an audio digitizing device that can listen to the conference, convert the audio signals to digital format, and forward the digitized signals to a user device via, for example, an audio streaming server. The audio streaming server may, for example, allow a user to connect to it via, for example, the Internet. Additionally, the audio streaming device may buffer or record the signals to permit the user to pause, rewind, and/or fast-forward thru the conference.

In yet another example, back end server(s) 420 may include a Single Number Short Message Service (SN SMS) server for interfacing service center 106 with a SMS gateway in voice network 104. This may be used for example to permit the user to have SMS messages addressed to the user's home phone number directed to an SMS capable device of the users choosing.

Voice network plane 508 includes the hardware and software included in voice network 104, as discussed above with reference to FIG. 3. For example, voice network plane 508 may include ISCP SPACE 314, ISCP 302, intelligent peripherals 320, and SSP 308. Additionally, voice network plane 508 may also include the hardware and software included in a wireless carrier's network, such as, for example, the mobile switching center, etc.

The following provides a more detailed description of methods and systems for line management. For example, when a call directed to a user at phone 114 arrives at SSP 310 servicing user's phone 114, the user may specify that an particular action be automatically taken. The specified action may be, for example, based on criteria, such as the calling parties name/number, the time/day, etc. These actions may include call forwarding, call forwarding based on the calling parties phone number, sending a call to voicemail, and playing an announcement. Additionally, these actions may also include playing a Supplemental Information Tone (SIT), such as described in U.S. Pat. No. ______, entitled Methods and Systems for Methods and Systems for Preemptive Rejection of Calls, (Attorney Docket No.: ______, which is incorporated by reference herein in its entirety. A SIT tone is a particular sequence of tones that are used to provide information regarding a number (i.e., a communications line), such as that the number is unavailable, and is further described in ITU Recommendation E.180 entitled Various tones Used in National Networks. Also, such actions may include blocking at user's direction all calls to user's phone and having him sent directly to voice mail. The following provides a more detailed description of exemplary embodiments for providing a user with the capability to manage one or more communications lines associated with the user such that calls directed to the communication line are handled automatically based upon user provided fine management information.

As discussed above, user terminal 112_A may execute a client application (hereinafter referred to as the Digital Companion (“DC”) client application). This DC client application preferably can access digital companion server(s) 406 via, for example, the Internet. This DC client application preferably may retrieve information from the digital companion server(s) regarding user's communication lines (e.g., the user's home phone, work phone, cell phone, etc.) that the user has elected to subscribe to digital companion services. Further, as discussed above, the user may also access and retrieve such information from the digital companion server(s) via a browser operating on a user terminal 112_B via communication portal 408. Or, as discussed above, the user may access and retrieve such information from the digital companion server(s) via voice portal 412 using a phone 114.

In this example, the user may be able to register, for example, using the DC client application or browser, one or more communications devices, that is, phones, wireless PDAs, computers, etc. with digital companion server(s) 406. This list of devices will be referred to as user's device profile and may include, for example, a name for the device, a phone number for the device if its is a phone, an IP address for the device if the device is a device with Internet connectivity (e.g., a wireless PDA, computer, etc.). This information may be provided by the user via, for example, the DC client application or browser. Or, if the communications line for the device is associated with the voice network, information may be retrieved by the communication portal, as discussed above.

As discussed above, in an exemplary embodiment, the user may elect to have all the user's calls for any of the user's communication lines (i.e., a communications device) automatically handled in a particular manner. The following provides a description of an example in which the user selects to have all calls to a particular one of the user's communications lines forwarded to another one of the devices in the user's device profile or to another user specified device or number. For example, if the user is planning on being away from the office, they may elect to have calls made to the user's office automatically forwarded to the user's cellular phone.

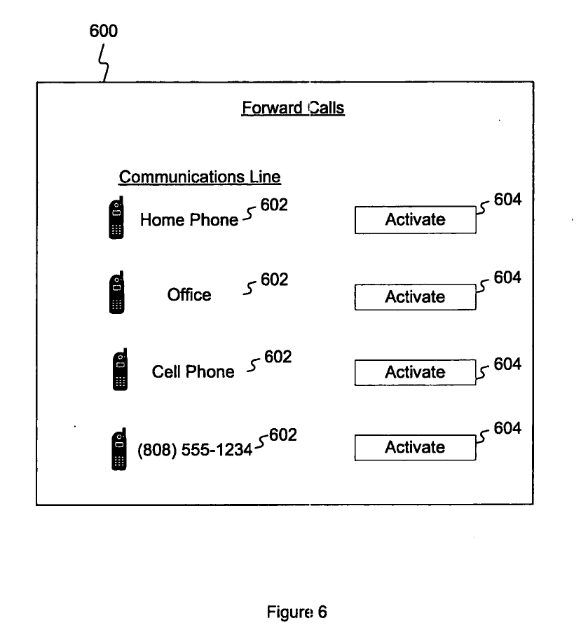

FIG. 6 illustrates an exemplary screen shot of a screen 600 that may be displayed to a user in response to the user electing to activate call forwarding. As illustrated, screen 600 may display the phone numbers or names 602 for the various devices in user's device profile (i.e., user's different communication lines) along with a corresponding activate call forwarding link 604. If a user desires to forward calls for one of the user's devices, the user can click on the activate call forwarding link 604 to the right of the phone's number (or name). In response, the user may be presented with a new screen for selecting the number to which the calls are to be forwarded.

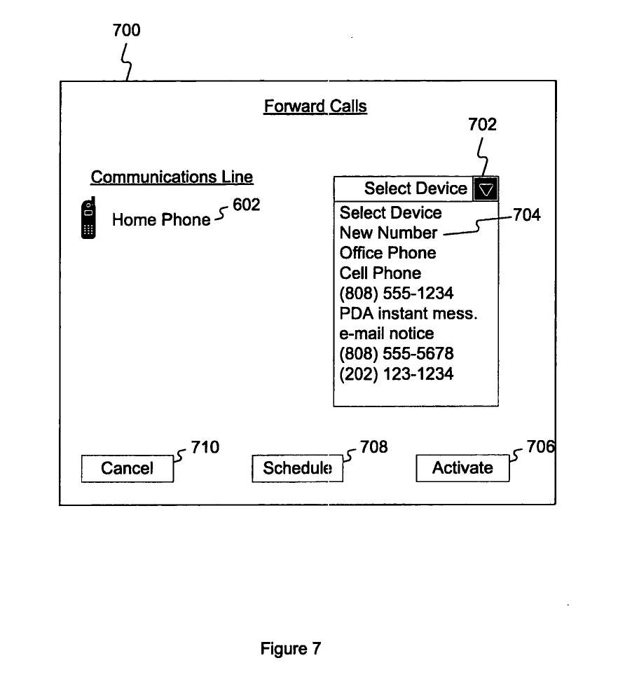

FIG. 7 illustrates an exemplary screen shot of a screen 700 that may be displayed to a user to select a number to which calls are to be forwarded (hereinafter referred to as a forward-to-number). As illustrated, screen 700 may display the number 602 for which the user has selected to have calls forwarded. Additionally, screen 700 may display a pull down list 702 that includes a selection of numbers to which the calls are to be forwarded and/or user assigned nicknames for these devices. Numbers in pull down list 702 may include, for example, the numbers and/or names for the other communication devices in user's device profile, along with any other numbers/names saved by the user. The user may then select from this pull down list 702, for example, to forward calls to the user's cellular phone. Or, for example, the user may select the user's e-mail from this pull-down list to have an e-mail regarding the call sent to him including information regarding the call. Or, the user may select an instant messaging account to have an instant messaging regarding the call sent to him.

If the user selects to have calls forwarded to a number (device) not listed, the user may select New Number entry 704 from the pull down list. In response, the user may be presented with a text box to enter a number and nickname to which to forward the calls. This number and nickname may then be saved so that in the future the number and/or nickname are displayed in pull down list 702.

Once the user has selected the device to which calls are to be forwarded, the user may then click on activate button 706 to have the user's changes saved so that the desired call forwarding is implemented. Alternatively, the user may click on cancel button 710 to cancel call forwarding.

Additionally, the call forwarding screens may include a box (not shown) for permitting a user to initiate call forwarding to a particular number in the event the called device is not answered within a particular number of rings. For example, a user may desire that if the user's home phone is not answered within 4 rings, that the call be forwarded to the user's cell phone or to some other number (e.g., a number for a vacation house). In such, an example, the user may enter the number “4” in such a box. Or if the user desires that calls be automatically forwarded, the user may enter a 0.

Screen 700 further illustrates a schedule button 708. As discussed above, the user may desire to schedule call forwarding based upon the time of day, day of week, etc. In the event the user desires to schedule call forwarding, the user may click on schedule button 708 to bring up a new screen for scheduling call forwarding.

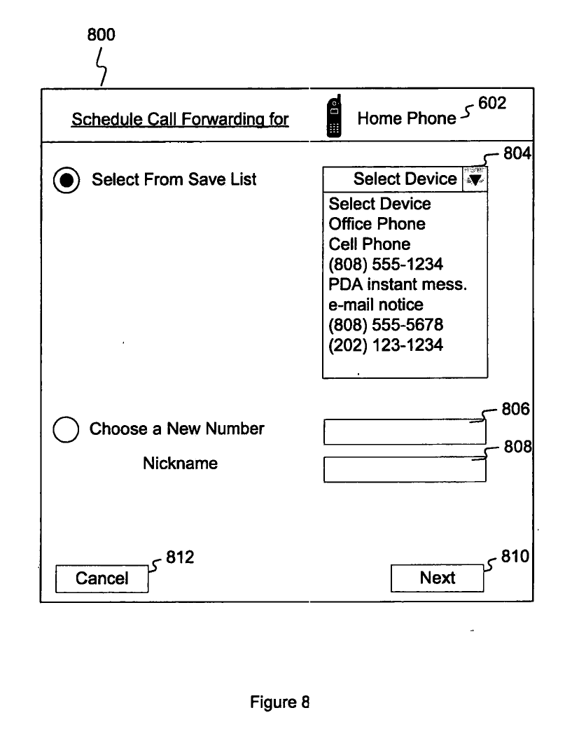

FIG. 8 illustrates an exemplary screen 800 that may be displayed to a user to schedule call forwarding. As illustrated, screen 800 may illustrate the number for which they want calls forwarded 602 and a pull down list 804. As with the pull down list discussed above, this pull down list 804 may include the numbers and/or names for the other devices in user's device profile along with other numbers and/or names previously saved by the user. The user may then select from this pull down list a name and/or number to which to forward calls.

If, however, the user desires to have calls forwarded to a device/number not specified in pull-down list 804, the user may enter the new number in a new number box 806. The user may further specify a nickname for this number by entering it in then nickname box 808. This number may then be saved by the application so that in the future the nickname is displayed in the pull down lists. After the user selects the number to which they wish for calls to be forwarded, the user may select next button 810 and a new page may be displayed to the user to enter the scheduling information. Alternatively, the user may click on cancel button 812 to cancel call forwarding.

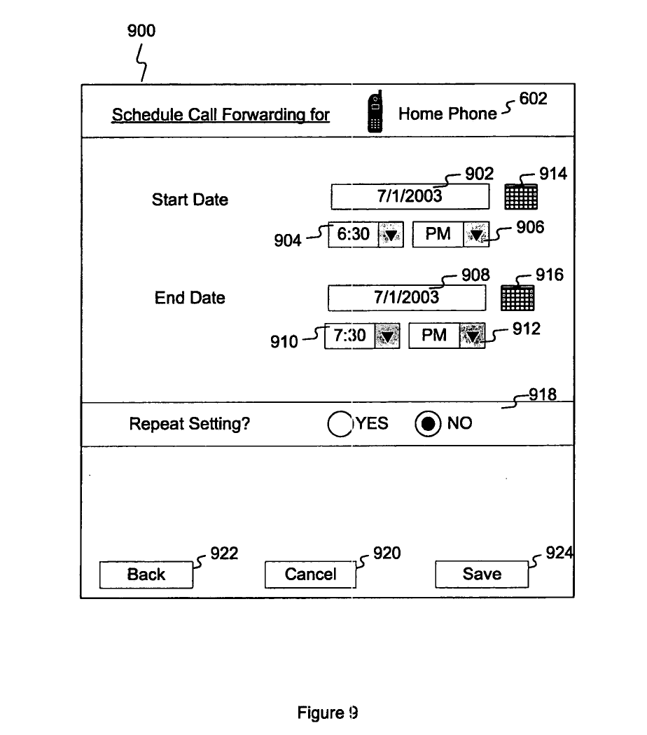

FIG. 9 illustrates an-exemplary screen 900 for entering scheduling information for call forwarding. As illustrated, the user may be presented with boxes for entering the start date 902, the start time 904, whether the start time is am or pm 906, the end date 908, the end time 910, and whether the end time is am or pm 912. Additionally, the user may be presented with a calendar button for selecting start date 914 and a calendar button for selecting end date 916. The calendar buttons 914 and 916 may be selected to display a calendar. The user may then select a particular day in the calendar and this date may then automatically be entered in start date 902 or end date 908 boxes, respectively.

Additionally, screen 900 may include a repeat setting check boxes 918 (e.g., yes or no) that a user may select if they wish for the user's call forwarding instructions to be repeated. For example, a user may desire that the call forwarding instructions be repeated daily, weekly, etc. If a user desires to have the user's call forwarding instructions repeated, the user may click on the yes box in the repeat setting check box 918. This in turn may cause additional options to be displayed to the user on screen 900.

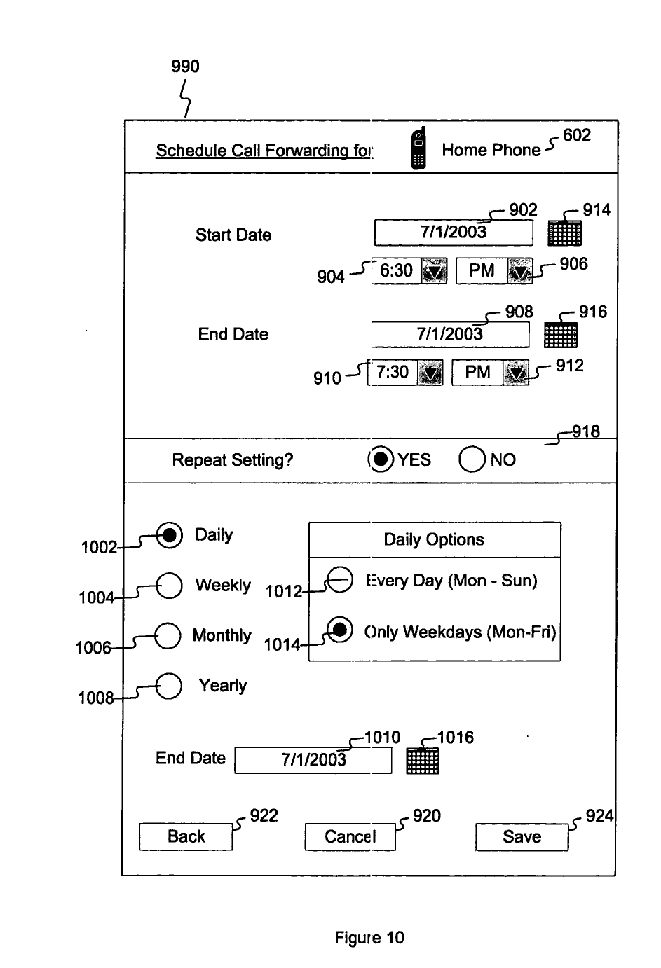

FIG. 10 illustrates an exemplary screen 990 for entering scheduling information for call forwarding where the user has selected to repeat the settings. As illustrated screen 990 includes check boxes for repeating the user's setting daily 1002, weekly, 1004, monthly 1006, and yearly 1008. Additionally, the screen includes a box for permitting the user to enter an end date 1010 for when the repeating is to end, along with a corresponding calendar button 1016 such as those described above. In this exemplary screen 1000, the user has selected the daily check box 1002. Accordingly, screen 1000 displays daily options to the user, such as for example, the option for the settings to be repeated ever day (Mon-Sun) 1012 or for the settings to be repeated only on weekdays (Mon-Fri) 1014.

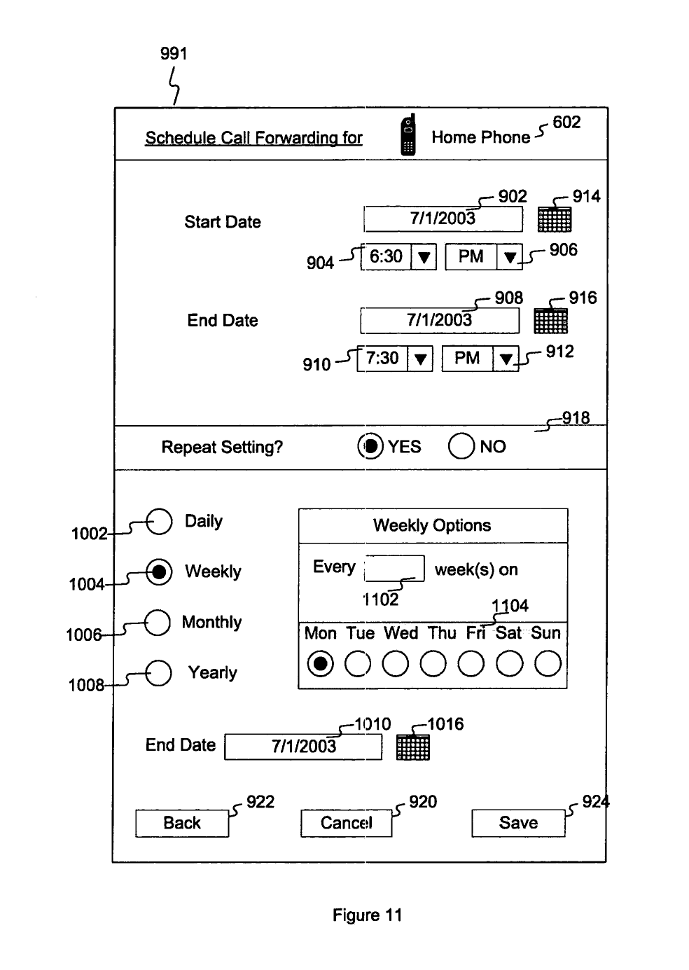

FIG. 11 illustrates an exemplary screen 991 for entering scheduling information for call forwarding where the user has selected to repeat the settings weekly. As discussed above, the user may select the weekly check box 1004. In response, screen 991 may display weekly options to the user, such as, for example, a box for entering how often they want the weekly setting repeated 1102 and check boxes for selecting the days of the week (i.e., Monday thru Sunday) for repeating settings 1104. For example, if the user wants the settings repeated every Monday and Tuesday, they may enter a 1 in box 1102 and select the check boxes for Monday and Tuesday 1104. Or, if, for example, the user wants the settings repeated every other week, they may enter a 2 in box 1102.

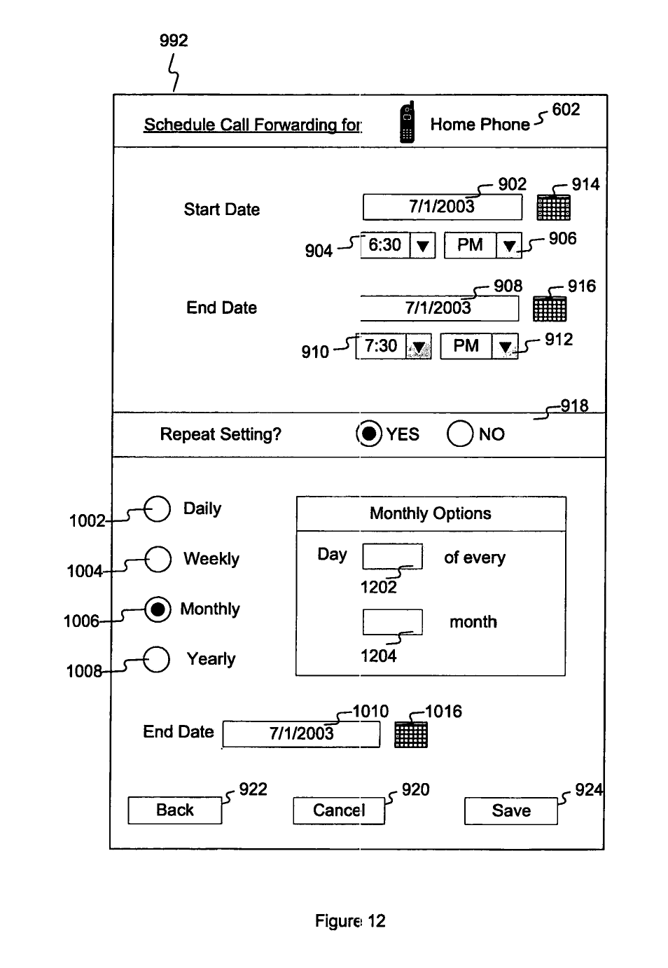

FIG. 12 illustrates an exemplary screen 992 for entering scheduling information for call forwarding where the user has selected to repeat the settings monthly. As discussed above, the user may select the monthly check box 1006. In response, screen 992 may display monthly options to the user, such as, for example, a box 1202 for entering a particular day during a month for repeating the call forwarding and a box 1204 for entering how often they want the monthly setting repeated. For example, if the user wants the call forwarding to occur on the fifteenth of every month, they may enter a fifteen in box 1202 and a one in box 1204. Or, if the user wants the call forwarding to occur on the fifteenth of every other month, they may enter a fifteen in box 1202 and a two in box 1204.

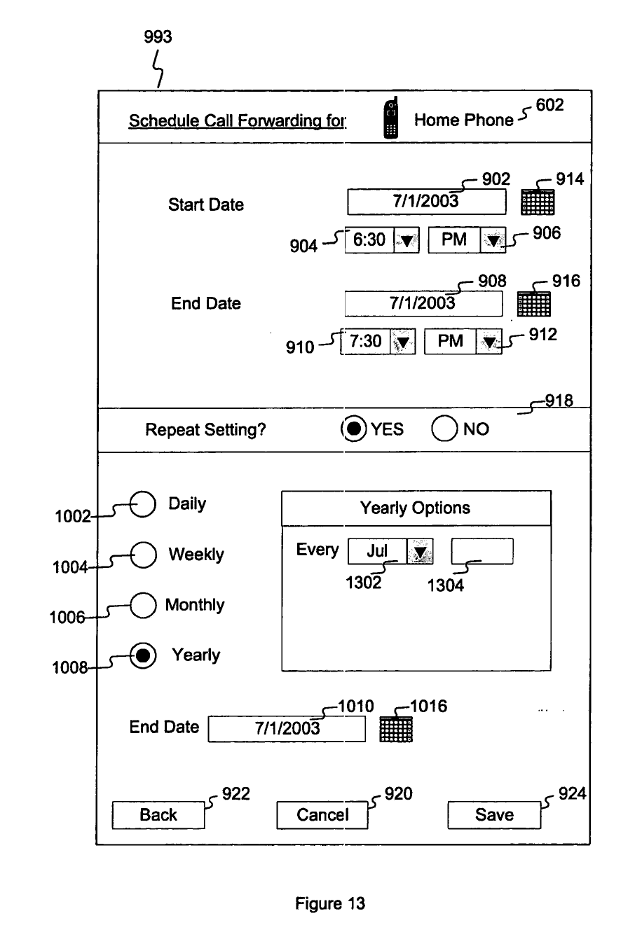

FIG. 13 illustrates an exemplary screen 993 for entering scheduling information for call forwarding where the user has selected to repeat the settings yearly. As discussed above, the user may select the weekly check box 1008. In response, screen 993 may display yearly options to the user, such as, for example, a pull down list for selecting a particular month 1302 and a box for entering a particular day 1304. Then, for example, if the user wants the call forwarding to occur on July 4th of every year, they may select July from pull down list 1302 and enter a four in box 1304.

After the user has entered the user's desired call forwarding instructions, the user may then select save button 924 to have the user's changes saved and to implement the desired call forwarding. Alternatively, the user may select cancel button 920 to cancel call forwarding or back button 922 to return to the previous screen.

Once a user enters the information to implement call forwarding for one of the user's communications lines and has saved the user's changes the information may be forwarded from user terminal 112_A to digital companion servers 406 which stores the information in database 522.

In addition to having all calls to a particular communications line (i.e., communication device) forwarded, in this example the user may also be able to select to have all calls to the communications line treated in some other manner. For example, the user may select to have all calls to a particular communications line blocked and sent directly to voice mail. In one example, the user may be able to simply check a box next to the name/number for the communication line to block calls and then save the changes.

In addition to automatically handling all calls to a particular communication line in a particular manner, the user may also be able to treat calls differently based on the caller ID of the incoming call. For example, a user may want calls made to the user's office phone from a particular person (e.g., an important user) to be forwarded to the user's cell phone, and calls from a different person (e.g., a friend) to be forwarded to the user's home phone. In such, an example, user's cell phone will be treated as the forward-to device for calls from the user, while the person's home phone will be treated as the forward-to device for calls from the user's friend.

As discussed above, the system may provide a user address book that includes names, phone numbers, and/or addresses of people and/or organizations entered by the user. Further, as discussed above, this address book may be stored in contacts database 530. A user wishing to add, delete or modify contacts in the user's address book may bring up the DC client application, which may include an option for modifying the address book.

The DC client application may then contact digital companion servers 406 to retrieve user's address book. If user terminal 112_A is connected to the Internet, this may be accomplished, for example, by the DC client application on user terminal 112_A retrieving the address book from digital companion server(s) 406. In another example, the user may access and modify the user's address book by directly contacting communication portal 408 via a user terminal (e.g., user terminal 112_B) executing an appropriate client application such as, for example, a web browser application.

Once the user terminal (e.g., 112_A or 112_B) has retrieved the user's address book, the user may then add, delete, or modify its listed contacts. Additionally, the address book may also include an entry for each contact regarding how calls from this particular contact are to be handled. As discussed above, a user may wish that all calls from a particular contact be forwarded to user's cell phone. The user may then select on a particular entry in the user's address book to bring up details regarding this contact.

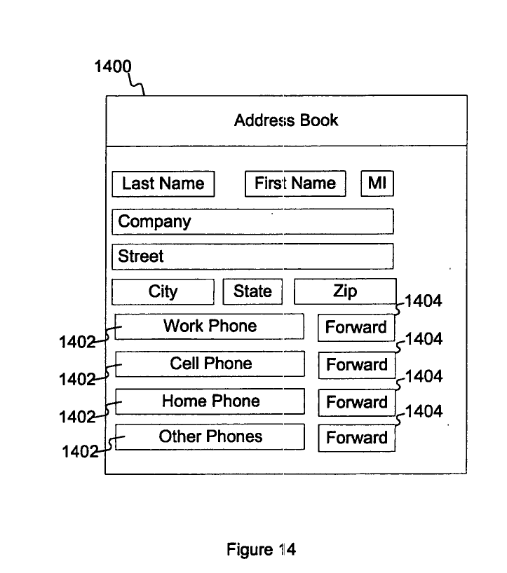

FIG. 14 illustrates a more detailed screen 1400 that, for example, a user may be presented with for a particular contact in the user's contact book. As illustrated, screen 1400 may include various phone numbers 1402 for the contact (e.g., a work number, cell phone number, home numbers, etc.). Additionally, screen 1400 may include a button for forwarding calls from this particular number 1404. A user may then click on this button to bring up subsequent screens for specifying how calls from this particular contact are to be treated. Such screens may, for example, be similar to the above-described FIGS. 7 through 13. Further, screen 1400 may also include additional buttons for selecting alternative handling of calls from this contact, such as, for example, blocking calls and forwarding him automatically to voice mail, playing a specially recorded message to the user, etc. Or, the screen may include a single button for selecting special handling. Then subsequent screens may be provided to the user so that the user may select the specialized handling. In the event, the user elects to play a announcement, the user may be presented with options for either selecting a prerecorded message or for recording an announcement. Also, this screen 1400 may also include a single button (not shown) for selecting a treatment for all numbers associated with the contact. Thus, rather than selecting individual treatments for each of the contacts numbers, the user may select such a button so that all calls from this contact are handled in a common manner.

Additionally, such screens may allow the user to modify a default handling for calls for which they have not specified a specialized treatment. For example, the user may desire that for calls for which they have not specified a particular handling, that some other action be taken, such as, for example, forwarding the call to a particular number, playing a SIT tone, etc. For example, the user may specify a default handling for calls by using screens such as discussed above with reference to FIGS. 7 through 13. Then, calls to this particular communication line are handled in this default manner unless a particular treatment is specified for calls from a particular number.

Additionally, rather than have calls forwarded to a phone, in an embodiment, a user may select to have calls forwarded to an application, such as for example, an instant messenger application on a wireless personal data assistant (PDA) so that an instant message regarding the call that may include the caller-ID information regarding the call is sent to user's PDA. Additionally, digital companion server(s) 406 may use the caller-ID of the caller determine if the caller is also registered with digital companion server(s) 406. If so, digital companion server(s) 406 may determine if the caller has registered an instant messaging application. Then, if the caller also has an instant messaging application, digital companion server(s) 406 may establish a communication session between the instant messaging applications and direct, for example, that can audible message be played to a caller that the call has been forwarded to an instant messaging application. Then, the caller and the user may send each other instant messages.

After the user makes the user's selections, the user can elect to save the user's changes, such that they are stored by digital companion server(s) 406 and/or communication portal 408. For example, once the user elects to save the user's changes, the DC client application on user terminal 112_A may send these changes to the digital companion server(s) via web server 514. Application server 516 may then save these changes in the appropriate databases.

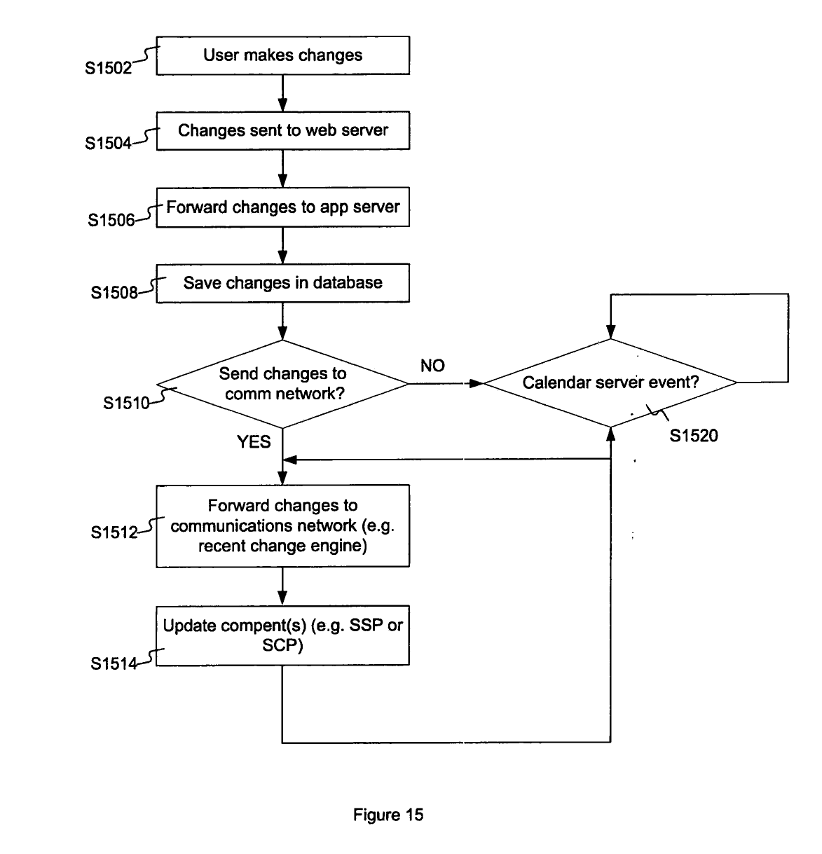

FIG. 15 illustrates a flow for chart for an exemplary method for implementing user's selections, in accordance with methods and systems consistent with the invention. As discussed above, a user can make changes regarding how they want calls treated. (S1502). The user can then save the user's changes, such that the user's changes are forwarded to digital companion servers 406.

In one example, user terminal 112_A executes a DC client application that may send the changes via the Internet to web server 514 of digital companion servers 406. (S1504). Web server 514 receives the changes and then may forward the changes to application server 516. (S1506). Application server 514 then may save the changes in database 522. (S1508).

Application server 516 may then determine whether the handling of calls to any of the user's communications lines changed and whether or not to forward any modifications to the communications network. (S1510).

If application server 516 determines to modify the communications lines, application server 516 may forward appropriate instructions to the effected communications lines. (S1512). For example, application server 516 may determine that a forwarding update should be sent so that all calls addressed to a particular number are to be forwarded. Then, application server 516 may forward an instruction to the appropriate component of voice network 104. For example, if the application determines a forwarding update should be made, it may send an appropriate instruction to communication lines SSP 310 or ISCP 302 via its respective recent change engine 316. A further description of forwarding updates is presented below.

In an exemplary embodiment, two types of forwarding updates may be used: a Call Forward Variable (CFV) update, and an AIN update. For example, if SSP 310 (FIG. 3) servicing the communications line being modified (in this example user's home phone 114) does not support AIN services, a CFV update may be performed to implement the desired call forwarding (e.g., if SSP 310 is an older type switch not supporting AIN services.) Otherwise, an AIN update may be performed.

Accordingly, in this example, if application server 516 (FIG. 5) determines SSP 310 does not support AIN services, application server 516 performs a CFV update. Application server 516 may then send the forwarding information to the appropriate recent change engine 316 using a switch update message. (S1512). The recent change engines 316 then updates the CFV forwarding number in user's SSP 310. (S1514).

In this exemplary embodiment, SSP 310 stores a table including information regarding the phone numbers supported by SSP 310. This table may also include information regarding whether the phone numbers subscribe to caller ID services, voice mail services, etc. Additionally, this table may include an entry regarding whether or not to forward calls originally directed to this phone number to a different number along with the number to which the calls are to be forwarded (i.e., the forward-to number). Accordingly, in the example, recent change engine 316 modifies the SSP's table to activate call forwarding and to insert the forward-to-number in the table. Then when SSP 310 receives calls originally directed to this phone number, it automatically forwards him to the forward-to number.

If, however, in this example, application server 516 determines that SSP 310 supports AIN services, application server 516 may transmit the forwarding information via an AIN update request message to the appropriate recent change engine 316. (S1512). Recent change engine 316 then updates its respective ISCP SPACE 314. (S1514). For example, ISCP SPACE 314 for ISCP 302 supporting SSP 310 may store information regarding how to treat calls originally directed to user's home phone 114, including whether or not calls are to be forwarded and, if so, to what number. ISCP SPACE 314 may then receive the data from recent change engine 316 and propagate local database(s) associated with ISCP 302. These databases may be, for example, internal or external to ISCP 302 and/or ISCP SPACE 314.

As discussed above, the user may also schedule a users call forwarding treatment. For example, a user may specify that calls from a particular contact be forwarded to the user's cell phone during evenings and on weekends, and calls from the same contact be forwarded to the user's office phone during the working hours of 9 a.m. to 5 p.m. on workdays. In such an example, when the time comes for the treatment to change, the calendar server 518 may send a message to application server 516 regarding the change in call treatment. (S1520.) In response, application server 516 may then transmit the modified forwarding information to the appropriate recent change engine 316 which in turn may transmit this information to SSP 310 or ISCP SPACE, as discussed above.

After the forwarding information is provided to SSP 310 or ISP SPACE 314, calls arriving at SSP 310 for user's phone 114 are automatically forwarded to the forward-to number.

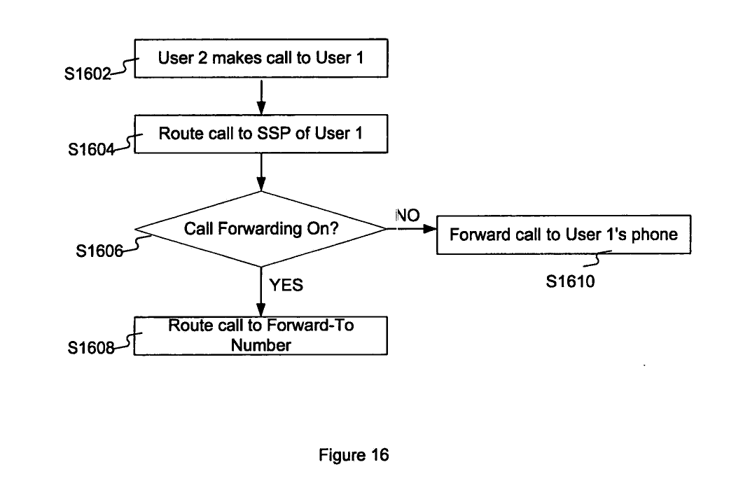

FIG. 16 illustrates a flow chart for a method for call forwarding by an SSP 310 updated via a CFV update, in accordance with methods and systems consistent with the invention. As illustrated, a caller 120 (‘user 2’) places a call to the DC users (“user 1”) home phone 114. (S1602) The call from calling party 120 traverses network 104 and reaches SSP 310 servicing the user. (S1604). SSP 310 then looks up in its table to determine if call forwarding is activated. (S1606). If so, SSP 310 routes the call to the stored forwarding number instead of to the user's home phone 114. (S1608). If call forwarding is not activated, SSP 310 routes the call to user's home phone 114. (S1610).

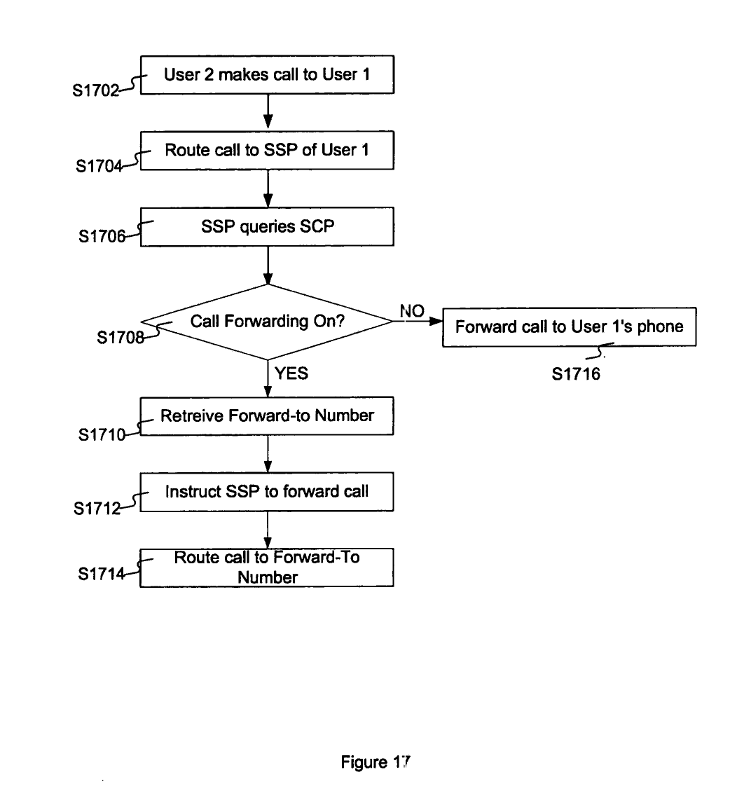

FIG. 17 illustrates a method for call forwarding for an SSP 310 providing AIN services, in accordance with methods and systems consistent with the invention. As illustrated, a caller places a call to the user's home phone 114. (S1702) The call from the calling party traverses network 104 and reaches the SSP 310 servicing user 1. (S1704). When the call reaches SSP 310, it results in an AIN trigger and SSP 310 launches a query to ISCP 302. (S1706). The service logic program of ISCP 302 may then look up in its database(s) whether call forwarding service is to be applied. (S1780). If so, ISCP 302 retrieves the forwarding number from the database(s). (S1710). The service logic program of ISCP 302 then sends its response to SSP 310 instructing it to route to call to the forwarding number. (S1712). In response, SSP 310 forwards the call to the retrieved forwarding number. (S1714). If, however, call forwarding is not activated for users home phone 114, ISCP 302 directs SSP 310 to forward the call to user's home phone 114. (S1716).

Additionally, as discussed above, a user may select to have calls treated differently based on identity of the calling party (e.g., caller-ID information) rather than simply forwarding all calls addressed to a particular communications device. If so, application server 516 of digital companion server(s) 416 may access the user's address book, calendar, etc. to create a disposition list for the device. This disposition list identifies how calls from different numbers (i.e., with different caller-IDs) are to be handled (e.g., where to forward the calls, play a message or SIT tone, etc.).

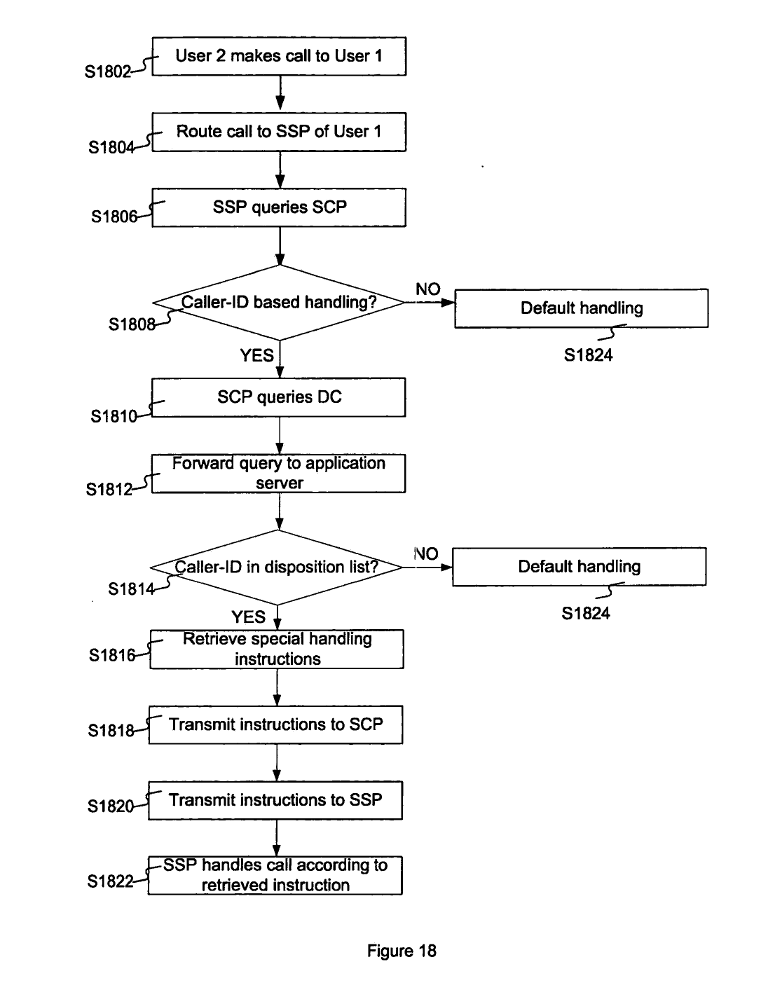

FIG. 18 illustrates a flow chart of a method for forwarding calls based on the caller-ID of the call in accordance with methods and systems consistent with the invention. First, a call is placed to the user's home phone 114. (S1802). The call is then routed by network 104 to SSP 310, which is associated with user phone 114. (S1804). SSP 310 then generates a trigger that is picked up by ISCP 302 (S1806). This trigger may be, for example, a Termination Attempt Trigger (TAT) or a specific Digit String (SDS). ISCP 302 then determines if special handling based on caller-ID should be applied. (S1808). If so, ISCP 302 queries Digital Companion server(s) 406 through network access server 410 (S1810). This query may include the caller-ID of the calling party's phone number (i.e., “caller-ID”).

This query is then forwarded to application server 516 of digital companion 406. (S1812). Application server 516 then looks up the caller-ID in the disposition list (S1814). If the number is found in the disposition list, application server 516 retrieves from the disposition list the handling for the call (S1816). Application server 516 then instructs ISCP 302 to handle the call according to the retrieved handling instructions (S1818). ISCP 302 then instructs SSP 310 how to handle the call (S1820). In response, SSP 310 handles the call according to the received instructions. (S1822).

In a first example, the call is to be forwarded to a particular number (“forward-to number”), such as for example, to a cell phone. In such an example, application server 516 may send an instruction to forward the call to ISCP 302 via network access server 410 (S1818). ISCP 302 may then instruct SSP 310 to forward the call to the forward-to number, i.e. to the cell phone (S1820). In response, SSP 310 forwards the call to the forward-to number (S1822). Further, as discussed above, the user may elect to only forward the call if the called number is not answered within a user specified number of rings.

In a second example, the caller-ID may not exist in the disposition list and application server 516 may elect to apply a user specified default treatment to the call (S1824). For example, the user may elect for home phone 114 to ring if no specific treatment is specified. In other examples, the default may be set to forward the call to a particular number such as mobile phone or a vacation number, if, for example, the user is on vacation. In such an example, the default handling may be stored in digital companion server(s) 406 and then retrieved arid forwarded by application server 516 to ISCP 302 as discussed above. Or, in another example, application server 516 may simply send an instruction to ISCP 302 to handle the call according to its default (e.g., the information stored in ISCP 302 or SSP 306 regarding handling of calls to this communications line).

In a third example, a user may select that calls from a particular caller-ID be sent directly to voice mail. In such an example, application server 516 may send an instruction to ISCP 302 forward the call to voice mail (S1818). ISCP 302 then may send an instruction to the SSP 310 (S1820). In response, SSP 310 forwards the call to an IP 320 providing voice mail services (S1822).

In a fourth example, the user may select that a SIT tone be played to the caller based on the caller-ID or in the event the caller-ID is unavailable. In such an example, application server 516 may send an instruction to play a SIT tone to ISCP 302. (S1818). In response, ISCP 310 may direct SSP 310 to forward the call to an IP which in turn plays a SIT tone. (S1820). The call may then be terminated or forwarded to voice mail, etc. (S1822). Alternatively, rather than playing a SIT tone, the user may direct that a particular voice recording be played to the caller based on the caller-ID.

In yet another example, the user may specify both a primary and a secondary handling procedure for calls, such that the secondary handling procedure is implemented if for example the primary handling procedure cannot be completed or some other criteria is met, such as, for example, user specified criteria. For example, the user may desire to have calls to their home phone from a particular contact ring the home phone, but if the home phone is busy or not answered within a specific number of rings then forward the call to the user's cell phone. The user may also be able to schedule these primary and secondary handling procedures.

The user may specify these primary and secondary handling procedures in a similar manner to the scheduling of a single handling procedure using screens such as those described above, wherein these screens provide the user with the ability to specify both primary and secondary handling procedures. Additionally, these screens may permit the user to specify when the secondary handling procedure should be used. For example, the user may specify that the secondary handling procedure be used if the primary handling procedure cannot be completed because the line is busy or not answered in a predetermined number of rings, or, if the phone is turned off or out of range as may, for example, be the case with wireless phones.

In the example of a user specifying both a primary and secondary handling procedure, when a call arrives at the communications line, the application server 514 may determine based on the user specified criteria, whether to apply the primary or secondary handling procedures. The application server 514 may then direct that the call be handled based on the determined procedure using methods and systems, such as those discussed above.

In another example, in addition to the user specifying that the handling procedure be based on a schedule, the user may also be capable of specifying the handling procedure based on the user's location. For example, the user may be able to specify for calls to be forwarded to their office phone if, for example, the user is logged on to the digital companion server(s) via a computer in the user's office. Or, for example, the user may specify that the calls be forwarded to the user's wireless phone if for example, the user is logged on to the digital companion server(s) via a wireless device, such as, for example, their wireless phone or a PDA. Additionally, in another example, the user may have a device with Global Positioning System (GPS) type capabilities such that the user's location is forwarded to the digital companion server(s) 416. The user in such an example may then specify how to handle calls from contact(s) based upon the information regarding the user's location.

In yet another example, the above-discussed screens may include options for adding contacts from the user's address book to various lists, such as for example, a selective call acceptance list, a selective call rejection list and a selective call forwarding list. For example, if a contact is added to the selective call acceptance list and the user has selected to block calls, then the digital companion server(s) 416 may determine whether or not the caller-ID information is on the selective acceptance list and if so complete the call to the called device, and if not, send the call to voice mail. If, for example, a contact is on the selective call rejection list, then calls from the contact may be sent directly to voice regardless of whether or not the user has selected to block all calls. Additionally, if, for example, a contact is on the selective call forwarding list, then the digital companion server(s) 416 may direct that calls from this contact be forwarded to a number associated with the selective call forwarding list.

In yet another example, the user may be able to define groups of contacts such that calls from any of the contacts in the group are handled in a common manner. For example, the user using screens similar to those discussed above may create a group of all contacts in the user's address book that work with the user. The user may then give this group a name (e.g., co-workers) such that this group becomes a separate entity in the user's address book. The user may then, for example, select a handling procedure for this group so that any call from any member of the group is handled according to the handling procedure for the group.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead is defined by the appended claims in light of the user's full scope of equivalents.

1-59. (canceled)

60. A method, comprising:
receiving, from the user over a data network, line management information regarding one or more communications lines associated with an account for a user;
receiving, from a communications network, information regarding a call received on at least one of the communications lines associated with the account;
determining handling of the call based on the received line management information; and
transmitting, to the communications network, an instruction regarding the handling of the call, such that the communications network handles the call in accordance with the received line management information.

61. The method of claim 60, wherein receiving the information regarding the call comprises receiving the information from a service control point providing services to a switch associated with the communications line.

62. The method of claim 60, wherein receiving the information regarding the call comprises receiving information identifying an origination of the call; and determining the handling of the call includes determining the handling based on the information identifying the origination of the call.

63. The method of claim 60, wherein receiving the line management information comprises receiving information regarding forwarding calls originally directed to one of the communications lines to a different communications line.

64. The method of claim 60, wherein receiving the line management information comprises receiving information regarding handling calls originally directed to one of the communications lines based on a time the call is received.

65. The method of claim 60, wherein receiving the line management information comprises receiving information regarding forwarding calls originally directed to one of the communications lines to one or more processors providing voice mail services.

66. The method of claim 60, wherein receiving the line management information comprises receiving information regarding forwarding calls for a particular communications line to one or more processors configured to play an audible signal indicative of the particular communications line being unavailable.

67. The method of claim 60, wherein receiving the line management information comprises receiving information regarding two or more communications lines associated with the user.

68. A system, comprising:
a first interface for connecting to a data network;
a second interface for connecting to a communications network; and
a set of one or more processors for receiving from a user, via the first interface, line management information regarding one or more communications lines associated with an account for the user, determining that the received line management information includes one or more modifications to at least one of the communications lines associated with the account, receiving, from the communications network, via the second interface, information regarding a call received on at least one of the communications lines, determining handling of the call based on the received line management information, and transmitting, via the second interface, to the communications network, instructions regarding the handling of the call.

69. The system of claim 68, further comprising a network access server for receiving the information regarding the call from a service control point, the service control point being configured to provide services to a switch associated with the communications line, and to transmit the information to the set of processors.

70. The system of claim 68, wherein the set of processors are further capable of receiving, from the communications network, information identifying an origination of the call, and determining the handling of the call based on the information identifying the origination of the call.

71. The system of claim 68, wherein the line management information includes information regarding forwarding calls originally defined for one of the communications lines to a different communications line.

72. The system of claim 68, wherein the line management information includes information regarding handling calls originally defined for one of the communications line based on a time the call is received.

73. The system of claim 68, wherein the line management information includes information regarding forwarding calls originally defined for one of the communications line to one or more processors providing voice mail services.

74. The system of claim 68, wherein the line management information includes information regarding forwarding calls originally defined for one of the communications line to a one or more processors for playing an audible signal indicative of the communications line being unavailable.

75. The system of claim 68, wherein the line management information includes information regarding two or more communications lines associated with the user.

76. A system, comprising:
means for receiving, from a user over a data network, line management information regarding one or more communications lines associated with an account for the user;
means for receiving, a the communications network, information regarding a call received on at least one of the communications lines associated with the account; and
means for determining handling of the call based on the received line management information;
means for transmitting, to the communications network, an instruction regarding the handling of the call, such that the communications network handles the call in accordance with the received line management information.

77. The system of claim 76, wherein the means for receiving the information regarding the call comprises means for receiving the information from a service control point providing services to a switch associated with the communications line.

78. The system of claim 76, wherein the means for receiving the information regarding the call includes means for receiving information identifying an origination of the call; and wherein the means for determining the handling of the call includes means for determining the handling based on the information identifying the origination of the call.

79. The system of claim 76, wherein the means for receiving the line management information comprises means for receiving information regarding forwarding calls originally directed to one of the communications lines to a different communications line.

80. The system of claim 76, wherein the means for receiving the line management information comprises means for receiving information regarding handling calls originally directed to one of the communications lines based on a time the call is received.

81. The system of claim 76, wherein the means for receiving the line management information comprises means for receiving information regarding forwarding calls originally directed to one of the communications lines to one or more processors providing voice mail services.

82. The system of claim 76, wherein the means for receiving the line management information comprises means for receiving information regarding forwarding calls for a particular communications line to one or more processors configured to play an audible signal indicative of a communications line being unavailable.

83. The system of claim 76, wherein the means for receiving the line management information comprises means for receiving information regarding two or more communications lines associated with the user.

84. A system, comprising:
a user device connected to a data network and configured to transmit information regarding handling of calls directed to a communications line associated with a user;
a storage for storing line management information regarding the communications line; and
a set of processors connected to the data network and a communications network, the set of processors being configured to receive, from the user device, the line management information regarding the communications line, store the received line management information in the storage, and transmit an instruction to a component of the communications network to implement the modification to the communications line;
wherein the component of the communications network is selected from the set of a switch for receiving calls directed to the communications line and a service control point associated with the switch.

85. A system, comprising:
a communications network, including:
a switch for receiving calls directed to a communications line associated with a user, and
a service control point associated with the switch;
a user device connected to a data network and configured to transmit information regarding handling of calls directed to the communications line associated with the user;
a storage for storing line management information regarding the communications line; and
a set of processors connected to the data network and the communications network, the set of processors being configured to receive, from the user device, the line management information regarding the communications line, store the received line management information in the storage, receive, from the communications network, information regarding a call directed to the communications line, determine handling of the call based on the stored line management information, and transmit, to the service control, point an instruction regarding the determined handling of the call, wherein the service control point directs the switch to handle the call in accordance with the determined handling.
